(19) United States
(12) Patent Application Publication
(10) Pub. No.: US 2025/0296608 A1
(43) Pub. Date: Sep. 25, 2025

(54) SYSTEM AND METHOD FOR INITIATING AN EMERGENCY BRAKE OF A GUIDED VEHICLE

(71) Applicant: Siemens Mobility SAS, Chatillon (FR)

(72) Inventors: Pierre Olivier Guislain, Chevreuse (FR); Andre Marco, Puteaux (FR)

(21) Appl. No.: 19/085,031

(22) Filed: Mar. 20, 2025

(30) Foreign Application Priority Data
Mar. 20, 2024 (EP) 24305414.5

(51) Int. Cl. B61L 27/04; B61L 15/00; B61L 25/02; G05D 1/65

(52) U.S. Cl. CPC B61L 27/04; B61L 15/0062; B61L 15/0081; B61L 25/021; B61L 25/025; G05D 1/65

(57) ABSTRACT

A system and a method for initiating an emergency braking of a guided vehicle, where the system is configured for cooperating with a braking system of the guided vehicle. The system includes a processing unit configured for initiating the emergency braking if it detects that a guided vehicle speed V at a guided vehicle position X exceeds a speed limit Vₗᵢₘᵢₜ that is defined for the position X in order to ensure that a speed V₀ is reached at a final position X₀ located upfront the guided vehicle on a route followed by the guided vehicle. The processing unit of the system is configured for automatically determining the speed limit Vₗᵢₘᵢₜ for the position X from an emergency brake rate function which varies in dependence on the guided vehicle speed at a remarkable position Pⱼ.

### CROSS-REFERENCE TO RELATED APPLICATION

This application claims the priority, under 35 U.S.C. § 119, of European Patent Application EP 24305414.5, filed Mar. 20, 2024; the prior application is herewith incorporated by reference in its entirety.

### FIELD AND BACKGROUND OF THE INVENTION

The present invention concerns a system and a method for initiating an emergency brake of a guided vehicle.

The present invention falls within the field of safe braking models for guided vehicle. The term “guided vehicle” refers to public transport means such as subways, trains or train units, metros, etc., as well as to load transporting means such as, for example, freight trains, for which safety is a very important aspect, and which are guided along a railway or track by guiding means, like a rail or a pair of rails. In particular, the present invention relates to Guaranteed Emergency Brake Rate (GEBR) that is defined as the minimum emergency brake rate achieved by a train on level tangent track under the range of environmental conditions and worst-case credible latent brake equipment failure modes, which can be anticipated to exist for that train in a specific application of a Communications-Based Train control (see the definition provided in IEEE Std 1474.1TM-2004: IEEE Standard for Communications-Based Train control (CBTC), Performance and functional Requirements).

According to current solutions, the GEBR that is taken for modelling and controlling emergency braking for a guided vehicle relies thus on a worst-case adhesion between the wheel of the guided vehicle and a wheel supporting surface (e.g. a rail or a ground) for all speeds of the guided vehicle. It is known, however, that the friction coefficient decreases with speed. Consequently, for some speeds, the value of the GEBR is smaller than it could be in reality while ensuring a same safety, which means also that the safe braking distance between guided vehicles, as well as headway between guided vehicles, that are used when considering the GEBR value, are greater than an optimal value they could take when considering the impact of velocity on the friction coefficient.

There is therefore a need to optimize the emergency braking of guided vehicles.

### SUMMARY OF THE INVENTION

It is accordingly an object of the invention to provide a system and a method which overcome the above-mentioned and other disadvantages of the heretofore-known devices and methods of this general type and which provide for a system and a method for initiating an emergency braking of a guided vehicle that are able to optimize the emergency braking as a function of a speed of the guided vehicle.

With the above and other objects in view there is provided, in accordance with the invention, a system for initiating an emergency braking of a guided vehicle, wherein the system is configured for cooperating with a braking system of the guided vehicle, the system for initiating the emergency braking comprising:
a processing unit configured for initiating the emergency braking if the processing unit detects that a guided vehicle speed V at a guided vehicle position X exceeds a speed limit Vₗᵢₘᵢₜ defined for the position X in order to ensure a speed V₀ at a final position X₀ located forward of the guided vehicle on a route followed by the guided vehicle;
said processing unit being configured for automatically determining the speed limit Vₗᵢₘᵢₜ for the position X from an emergency brake rate function which varies as a function of the guided vehicle speed V at a remarkable position Pⱼ.

In other words, according to the invention, there is proposed a system for initiating an emergency braking (called hereafter “EB system”) of a guided vehicle, wherein the EB system is configured for cooperating with a braking system of the guided vehicle, the braking system being capable of performing the emergency braking typically under control of the EB system according to the invention.

According to the present invention, the EB system for initiating an emergency braking comprises:
a processing unit, comprising typically a processor, the processing unit being configured for initiating the emergency braking if it detects that a guided vehicle speed V at a guided vehicle position X exceeds a speed limit Vₗᵢₘᵢₜ defined for the position X for the guided vehicle in order to ensure, for the guided vehicle, a speed V₀ at a final position X₀ located upfront the guided vehicle on a route followed by the guided vehicle;
the EB system being characterized in that the processing unit is configured for automatically determining the speed limit Vₗᵢₘᵢₜ for the position X from, or in function of, an emergency brake rate (hereafter “EBR”) function which varies in function of the speed of the guided vehicle. Typically, for a given remarkable position Pⱼ, the EBR function varies in function of the guided vehicle speed at the remarkable position Pⱼ. According to the present invention, the EBR function takes therefore different values in function of the guided vehicle speed at the remarkable position Pⱼ, wherein the remarkable position Pⱼ is typically located upfront the guided vehicle with respect to its (current) position X (i.e. downstream with respect to the motion direction of the guided vehicle).

The present invention also concerns a method for initiating an emergency braking of a guided vehicle by means of the above-mentioned EB system that is configured for cooperating with the braking system of the guided vehicle, the method according to the invention comprising the following steps:
determining whether a speed V of the guided vehicle at a guided vehicle position X exceeds a speed limit Vₗᵢₘᵢₜ defined for the position X for the guided vehicle;
initiating the emergency braking if the guided vehicle speed V at the guided vehicle position X exceeds the speed limit Vₗᵢₘᵢₜ in order to ensure, for the guided vehicle, a speed V₀ at a final position X₀ located ahead of the guided vehicle on a route followed by the guided vehicle;
the method being characterized by the following step:
automatically determining the speed limit Vₗᵢₘᵢₜ for the position X from an emergency brake rate function which, for a given remarkable position Pⱼ, varies in function of the guided vehicle speed at the remarkable position Pⱼ.

Compared to existing techniques, the present invention proposes thus to determine the speed limit Vₗᵢₘᵢₜ by taking into account variations of values taken by the EBR function in function of the speed of the guided vehicle. By this way, it becomes possible to take into account variations of the adhesion between a guided vehicle wheel and a wheel supporting surface in function of the speed of the guided vehicle.

Other features which are considered as characteristic for the invention are set forth in the appended claims.

Although the invention is illustrated and described herein as embodied in a system and method for initiating an emergency brake of a guided vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 schematic illustration of a network according to the invention.

FIG. 2 schematic illustration of an EBR function according to the invention.

FIG. 3 schematic illustration of a guided vehicle comprising an EB system according to the invention.

FIG. 4 schematic illustration of a speed limit in function of the position according to the invention.

FIG. 5 schematic illustration of an optimization of the speed limit in function of the position of the guided vehicle and its length according to the invention.

In the drawings like numerals are used for like and corresponding parts:

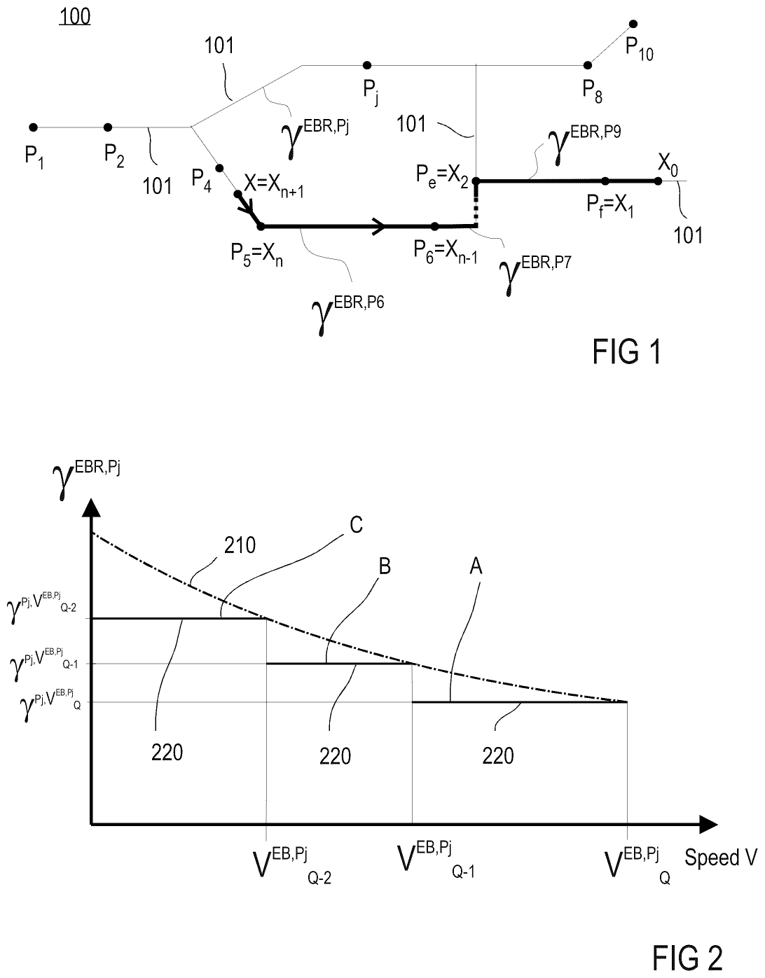

FIGS. 1 to 5 show preferred embodiments of the invention and will be used hereafter for better explaining the concept of the invention.

### DETAILED DESCRIPTION OF THE INVENTION

Referring now to the figures of the drawing in detail and first, in particular, to FIG. 1 thereof, there is shown a route network 100. The route network 100 comprises different segments of routes or tracks 101 that interconnect or intersect at some points in order to form the network 100. The route network 100 is for instance a network of a public transport, e.g. a railway network. Such route networks are well-known to the skilled persons and do not need to be further described here.

Guided vehicles according to the invention are configured for travelling or moving on the route network 100, i.e. along the route or track segments. The path or route followed by the guided vehicle, which can be defined as a succession of the route or track segments, is notably predefined, i.e. the starting and ending points of the route are known, the guided vehicle having to move from the starting point towards the ending point. In other words, the itinerary followed by the guided vehicle is known. In this context, the present invention proposes a new way of determining a speed limit Vₗᵢₘᵢₜ that is used by the EB system according to the invention for automatically initiating an emergency braking of the guided vehicle in case a speed of the guided vehicle would exceed the speed limit Vₗᵢₘᵢₜ.

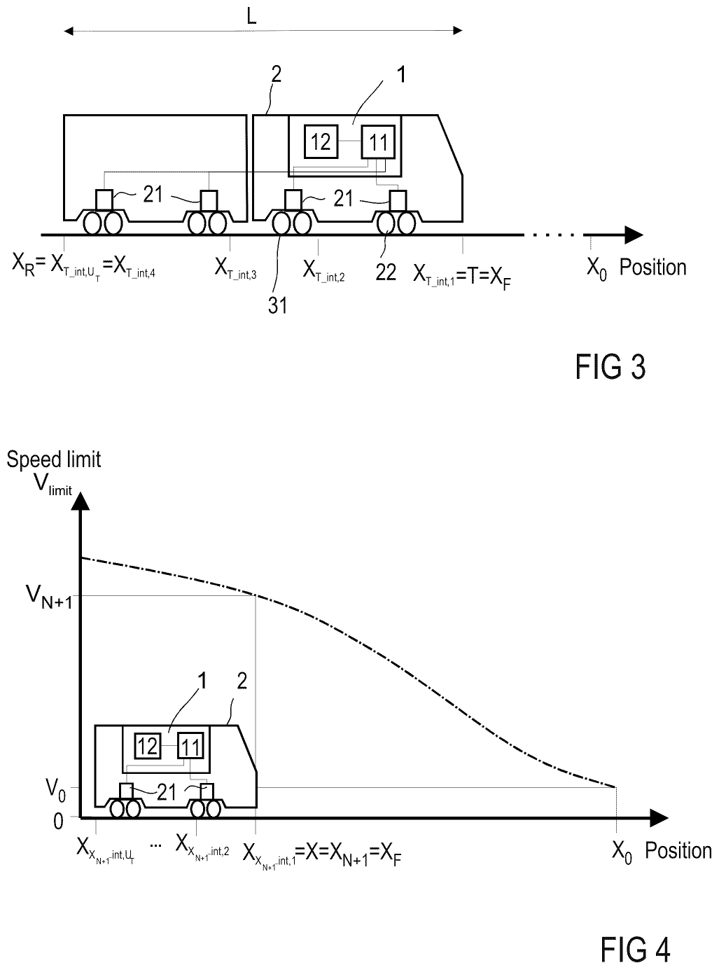

FIG. 3 schematically represents an EB system 1 according to the invention installed within a guided vehicle 2. The present invention also concerns a guided vehicle 2 comprising the EB system 1 according to the invention. The EB system 1 is configured for cooperating with a braking system 21 of the guided vehicle 2, wherein the braking system 21 is able to carry out an emergency braking of the guided vehicle 2. In particular, the EB system according to the invention is connected to the braking system for enabling a sending of a signal configured for launching the emergency braking by the braking system. For instance, the EB system 1 comprises a processing unit 11 comprising at least one processor, wherein the processing unit further comprises at least one output configured for being connected to the braking system 21 in order to send to the braking system 21 the signal configured for launching the emergency braking of the guided vehicle. Typically, the processing unit 11 is configured for comparing a current speed of the guided vehicle at a current position X with a speed limit Vₗᵢₘᵢₜ defined for the current position X as illustrated in FIG. 4, and for automatically sending the signal if the current speed exceeds the speed limit. For this purpose, the EB system 1, preferentially its processing unit 11, is configured for acquiring or receiving the current position and speed of the guided vehicle, preferentially in real time.

The guided vehicle 2, for instance a train, typically comprises wheels 22 configured for running on a contact surface 31 of the route or track segment, wherein the braking of the wheels is controlled by the braking system 21. For instance, the contact surface might be a top surface of a head of a rail equipping the route or track segment, wherein wheels 31 of the guided vehicle 2 are configured for running on the top surface of the rail head. The adhesion of the guided vehicle wheels with the contact surface of the route or track during a braking implemented by the braking system 21 determines the efficiency of the emergency braking realized by the guided vehicle. It is then clear that within the route network 100, the guided vehicle might follow different routes, and for each route, different adhesion conditions might be faced by the guided vehicle. In other words, the adhesion of the wheels on the contact surface is not uniform across the whole network 100.

The present invention proposes to better adapt or adjust the speed limit Vₗᵢₘᵢₜ that is used for triggering the emergency braking in function of different adhesion conditions that might be faced by the guided vehicle 2 on the network 100 so that a speed V₀ might be ensured at a final position X₀, for ensuring for instance that the guided vehicle be at standstill at the position X₀. Of course, the speed V₀ and the final position X₀ are known and predefined parameters, wherein the speed V₀ is superior or equal to 0. More precisely, the present invention proposes an EB system 1 that is capable of optimizing the emergency braking of the guided vehicle in function of a variation of adhesion conditions that might be faced by the guided vehicle moving on the network 100, and notably, in function of a variation of the adhesion in function of the speed of the guided vehicle 2. More practically, when the EB system 1 detects that, at a position X (i.e. the current position of the guided vehicle on the network 100), the speed limit Vₗᵢₘᵢₜ determined for the position X is exceeded, then it automatically sends the signal to the braking system 21 for initiating the emergency braking which aims to bring the guided vehicle at the speed V₀ at the final position X₀ located upfront the guided vehicle on the route followed by the latter.

While existing emergency braking techniques developed for guided vehicles propose different emergency brake rates along the track, wherein each emergency brake rate is assumed constant whatever the speed of the guided vehicle, the prevent invention introduces a double dependency of the emergency brake rate on both the position of the guided vehicle on the track and its speed. Indeed, the present invention proposes to calculate, notably by using an iterative process, the speed limit Vₗᵢₘᵢₜ in function of an EBR function that varies with the speed of the guided vehicle 2. This enables to better adjust the value of the speed limit Vₗᵢₘᵢₜ in function of varying adhesion conditions of the route followed by the guided vehicle.

An illustration of the EBR function in function of the guided vehicle speed V is shown in FIG. 2 for a position Pⱼ. As illustrated by the dash-dotted line 210, values of the EBR function vary in function of the speed V of the guided vehicle. In other words, depending on the speed of the guided vehicle at the position Pⱼ, the EBR function value might be different. Typically, the EBR function illustrated in FIG. 2 decreases with increasing speeds, that is

$${g}^{EBR , {P}_{j}} ( {V}_{Q - 2}^{EB , {P}_{j}} ) = {γ}^{{P}_{j} , {V}_{Q - 2}^{EB , {P}_{j}}} > {g}^{EBR , {P}_{j}} ( {V}_{Q - 1}^{EB , {P}_{j}} ) = {γ}^{{P}_{j} , {V}_{Q - 2}^{EB , {P}_{j}}} for$$

$${V}_{Q - 2}^{EB , {P}_{j}} < {V}_{Q - 1}^{EB , {P}_{j}} .$$

In particular, the EBR function defined for, or associated with, a first position might be different from the EBR function defined for or associated with a second position different from the first position, so that for a same guided vehicle speed, the corresponding value of the EBR function might be different when considering different positions on the network 100.

The present invention proposes in particular to store in a memory or database 12 of the EB system 1 according to the invention, and at least for the route followed by the guided vehicle, a set S of positions Pⱼ, called hereafter “remarkable” positions Pⱼ, with j=1, . . . , M, i.e., S={P₁, . . . , P_{M}} with M≥1, located along the route that has to be followed by the guided vehicle. Preferably, such remarkable positions Pⱼ located along route or track segments of the route network are stored for the whole route network 100. The goal is to define and store for the route followed by the guided vehicle, preferentially for the whole network, such remarkable positions at specific location of the network, wherein the remarkable positions are positions that may impact the emergency braking of the guided vehicle. Each of the remarkable positions is typically characterized by coordinates which enable to locate the remarkable position within the network 100, enabling thus to determine at which positions of the network 100, the EB system has to take care about parameters or conditions impacting the emergency braking. Examples of remarkable positions are illustrated by P₁, P₂, P₄, P₅, P₆, P₈, P₁₀ in FIG. 1.

Preferably, each remarkable position Pⱼ belongs to at least one of the following types of positions:
Type I: it is a position along the route at which there is a change of adhesion value between a guided vehicle wheel and a surface on which the wheel is configured for running; and/or.
Type II: it is a position along the route at which there is a change of gradient value with respect to the surface on which the wheel is configured for running (i.e. the gradient being a measure of a deviation of the surface from the horizontal, corresponding thus to the slope of the route at the remarkable position Pⱼ); and/or
Type III: it is a position along the route at which there is a constraint of speed V_{constraint speed} (i.e. each position of type III is associated to a speed constraint, imposing for instance a maximal speed=V_{constraint speed} at the remarkable position).

In particular, for each remarkable position Pⱼ of Type I, the database or memory 12 stores an EBR function g^{EBR,P}^{ⱼ}(V) that is a function of the speed V of the guided vehicle at the remarkable position Pⱼ, i.e. g^{EBR,P}^{ⱼ}(V)=g^{P}^{ⱼ}^{,v}. Preferentially, such EBR function is stored for, or at least associated with, each remarkable position. Indeed, and preferentially, if the EBR function is stored only for the remarkable positions of type I, then the processing unit might be configured for determining the EBR function associated with any other type of remarkable positions from the EBR function stored for the remarkable positions of type I, as explained hereafter, preferentially storing then for each remarkable position an EBR function.

Therefore, and preferentially, for each remarkable position Pⱼ according to the present invention, the database or memory 12 stores or associates an EBR function g^{EBR,P}^{ⱼ}(V) that is a function of the speed V of the guided vehicle at the remarkable position Pⱼ, with g^{EBR,P}^{ⱼ}(V)=g^{P}^{ⱼ}^{,v}. The EBR function g^{EBR,P}^{ⱼ}(V) associated to the remarkable position Pⱼ assigns thus an EBR value g^{P}^{ⱼ}^{,v} to a speed value V of the guided vehicle. In particular, for a given direction of travel of the guided vehicle along a route towards the remarkable position Pⱼ, the EBR function g^{EBR,P}^{ⱼ}(V) defined for the remarkable position Pⱼ applies to (i.e. is associated with) any position X′ along the route that is located between the remarkable position Pⱼ and a remarkable position Pᵣ of the set S, with r≠j, r∈{1, . . . , M}), wherein the remarkable position Pᵣ is a directly previous remarkable position with respect to the remarkable position Pⱼ when following the route towards Pⱼ according to the given direction. Preferentially, if the database or memory stores the EBR function only for the remarkable position of type I, then Pⱼ and Pᵣ are remarkable positions of type I, and the EBR function that is associated to or that applies to any remarkable position (different from the type I) located between Pⱼ and Pᵣ is determined by the processing unit of the EB system as previously explained.

In other words, between two directly neighboring remarkable positions (notably when they are remarkable positions of type I), the EBR function defined for, or associated with, one of the directly neighboring remarkable positions applies to any point comprised between the directly neighboring remarkable positions. The preferred embodiment described above is based on the assumption that the EBR function that applies to the positions located between two directly neighboring remarkable positions, that are preferentially of type I, is the one of the directly neighboring remarkable position that will be crossed the latest when the guided vehicle is following the route on the network according to the direction of travel. This assumption has been made for simplifying the explanation of the concept of the invention. Of course, other ways of defining which one of the EBR functions of directly neighboring remarkable positions, that are preferentially of type I, applies might be defined by the skilled person. For instance, for the guided vehicle moving from a first remarkable position (that is preferentially of type I) to a second remarkable position that is a direct neighbor (and preferentially of type I) to the first remarkable position, one can also have the EBR function of the first remarkable position applying to any position comprised between the first and the second remarkable position. In any case, the set of remarkable positions (or at least the set of remarkable positions of type I) is used by the EB system for determining which EBR function applies on, or is assigned to, each section of route connecting and comprised between two directly neighboring remarkable positions of the set, the EBR functions of one of the directly neighboring positions applying to the set of positions of the route section comprised between the two directly neighboring positions.

As illustrated by the dash-dotted line 210 of FIG. 2, the EBR function assigns different EBR values to different speed values. The aim of the EBR function is to model the adhesion of the guided vehicle wheels to the contact surface in function of the speed of the guided vehicle. Different models might be used by the skilled person for modeling the adhesion. For instance, the EBR function might be a piecewise constant function taking constant values on successive speed intervals according to

$${g}^{EBR , {P}_{j}} ( V ) = {γ}^{{P}_{j} , {V}_{t}^{EB , {P}_{j}}} = constant\_t$$

if Vₜ₋₁^{EB,P}^{ⱼ}≤V≤Vₜ^{EB,P}^{ⱼ}, with t=1, . . . , Q, Q≥2 being the number of speed intervals, Q and t being positive integers. Such a piecewise constant function is illustrated in FIG. 2 by the line segments 220, with notably constant_1>constant_2> . . . >constant_Q−1>constant_Q. In other words, the value of the EBR function is considered as constant for successive sets of speeds of the guided vehicle, each set being associated to a different constant value of the EBR function. Of course, other models might be chosen by the skilled person.

Preferably, the processing unit 11 is further configured for automatically determining, for a position T (see FIG. 3) along the route followed by the guided vehicle 2, a set L3_{T} of guided vehicle internal positions that are located within the guided vehicle along its length L between its front end and its rear end and which are defined for the position T (the set L3_{T} being thus defined for the position T), wherein the guided vehicle is taken as frame of reference for defining the internal positions. In the following, X_{F} will be the position of the front end of the guided vehicle, and X_{R} the position of its rear end, with |X_{F}−X_{R}|=L, i.e. the guided vehicle length L. Of course, the positions X_{F} and X_{R} change when the guided vehicle is moving along the route, the set L3_{T} comprising internal positions comprised between X_{F} and X_{R} and defined for the guided vehicle being at the position T, i.e. when the front end of the guided vehicle is at the position T. For determining the set L3_{T}, the processing unit is notably configured for:
determining a first set L1_{X0} of internal positions X^{intern_1,X}₀ located along the length of the guided vehicle, between the front end position X_{F} of the guided vehicle and its rear end position X_{R}, which, when the front end of the guided vehicle is located at the final position X₀, i.e. X_{F}=X₀, correspond each to (i.e. are located each at the same position as) one of the remarkable positions Pⱼ;
determining a second set L2_{T} of guided vehicle internal positions X^{intern_2,T} located, along the length of the guided vehicle, between X_{F} and X_{R}, which, when the front end of the guided vehicle is located at the position T, e.g. T=X_{F}=X, correspond each to one of the remarkable positions Pⱼ;
creating the set L3_{T} as the union of L1_{X0} and L2_{T}, wherein L3_{T} further comprises the positions X_{F}=T and X_{R}, and optionally, other internal positions located between X_{F} and X_{R}, wherein, for simplicity, L3_{T} is written as L3_{T}={X_{R}, {X^{intern_1,X0}}, {X^{intern_2,T}}, X_{F}}={X_{T_int,f}} with f=1, . . . , U_{T}, U_{T} being equal to the number of positions (or elements) comprised within L3_{T} for the position T, and wherein, for simplicity, the positions X_{T_int,f} are ordered from the most distant position from X_{F} to the closest position to X_{F} with decreasing f, that is X_{T_int,U}_{_{T}}=X_{R}, X_{T_int,U}_{_{T−1}}, . . . , X_{T_int,2}, X_{T_int,1}=X_{F}. Such internal positions are illustrated in FIGS. 3 and 4. Advantageously the other internal positions enable to better take into account the length of the guided vehicle when calculating the speed limit. Indeed, adding such other internal positions may reduce a gap between an optimal speed limit and the calculated speed limit, given that the present invention aims to find a value for the speed limit that tends to the value of the optimal speed limit. In particular, such other internal positions are added to L3_{T} if a distance between two directly neighboring remarkable positions that are located “below” the guided vehicle when it is located at a considered position (e.g. when its front end is located at the position X) is larger than a predefined distance chosen in function of the guided vehicle length, e.g. larger than L/2 or L/3.

In particular, the processing unit is further configured for automatically adding, to the set S of remarkable positions, for each internal position X_{T_int,f} comprised in L3_{T}, a first position (i.e. an additional remarkable position) along the route that corresponds to (i.e. is located along the route at a same place as) the internal position X_{T_int,f} when the front end of the guided vehicle is located in X₀ and a second position (i.e. another additional remarkable position) along the route that corresponds to the internal position X_{T_int,f} when the front end is located in T, if such first position, respectively second position, is not yet comprised within S. In other words, the first and second positions are only added to the set S if they are not yet comprised in the set S, otherwise, they are ignored, i.e. not added to the set, so that duplicate are avoided.

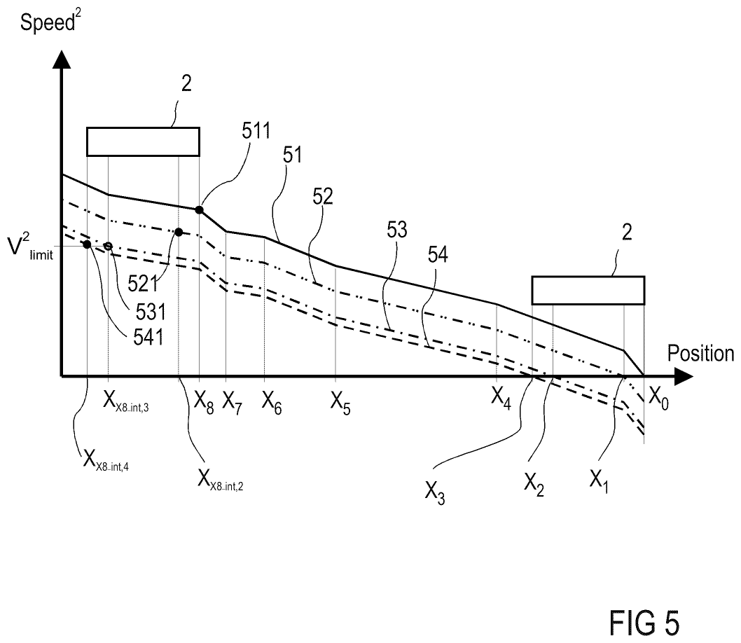

These added remarkable positions enable to determine an optimized value of the speed limit Vₗᵢₘᵢₜ by taking into account the length L of the guided vehicle and potential changes of adhesion conditions that may take place at positions located below the guided vehicle when the latter is located at the position T. This is notably illustrated by FIG. 5, wherein the guided vehicle 2 is schematically represented by a rectangle. Indeed, critical situations may occur, wherein along the length L of the guided vehicle, some internal positions may require a more restrictive speed limit that the one that might be calculated by assigning to the guided vehicle a single position being for instance X_{F}. Therefore, the present invention proposes to take into account the length of the guided vehicle by determining whether it exists a position, located between the front end and the rear end of the guided vehicle, and for which of the speed limit Vₗᵢₘᵢₜ determined for the position would be more restrictive that the speed limit calculated for any other position between the front end and rear end. This will be better explained in the following.

Preferably, according to the present invention, the method comprises, and the processing unit is configured for, automatically calculating the speed limit Vₗᵢₘᵢₜ by implementing an iterative calculation process. As explained earlier, when the guided vehicle is moving on the network, it follows a route that has been defined in advance, and therefore the itinerary followed by the guided vehicle on the network is known. The iterative calculation process is configured for calculating the speed limit Vₗᵢₘᵢₜ for the position X of the guided vehicle from the speed V₀ required at the final position X₀ and by iteratively calculating, for each remarkable position between X and X₀ that is encountered when going from X₀ to X along the route followed by the guided vehicle, the speed that is required at a next remarkable position (when going from X₀ to X) for satisfying the speed obtained for a previous remarkable position (when going from X₀ to X) when applying an emergency braking according to the concerned EBR function. In particular, the iterative calculation process comprises, according to the present invention:
an automatic determination of a subset S′ of the set S of remarkable positions Pⱼ comprised along a section of the route defined for the guided vehicle, wherein the section of route is comprised between the position X of the guided vehicle (i.e. its current position, which is the position on the network where the guided vehicle is located when it performs the iterative calculation process for determining the speed limit Vₗᵢₘᵢₜ) and the final position X₀ to be reached by the guided vehicle when moving along the section of route from the current position X towards the final position X₀ according to the given travel direction. The speed of the guided vehicle at the final position is the final speed V₀ that is a predefined parameter. For instance, the final position might be one of the remarkable positions Pⱼ that is of type III, in which case the final speed V₀ might be a speed constraint imposed to the guided vehicle at the final position. Typically, the subset S′ may comprise N of the remarkable positions Pⱼ, which, for simplicity, are ordered in the set S′ according to increasing distance from the final position X₀ (the distance being measured along the section of route) and noted X₁, . . . , X_{N} with N≤M, i.e. S′={X_{j′}} with j′=1, . . . , N, wherein X₁ is the remarkable position Pⱼ of the subset S′ that is the closest to the final position X₀ on the section of route, and X_{N} is the remarkable position Pⱼ of S′ that is the closest to the position X of the guided vehicle, wherein X_{N+1} is set to be equal to X (i.e. X=X_{N+1}). Such an ordering of the remarkable positions Pⱼ in the subset S′ is of course optional, but it simplifies here the description of the concept according to the invention. Given the ordering, X₁, . . . , X_{N} are thus remarkable positions of the network 100 that correspond to the remarkable positions Pⱼ of the set S that are located on the section of route between X and X₀, and ordered along the section of route according to decreasing value of j′ when moving from X to X₀, the guided vehicle successively encountering therefore X_{N}, X_{N-1}, . . . , X_{j′}, . . . , X₁, when moving from X to X₀, N being the number of remarkable positions X_{j′} within the subset S′. In particular, X_{N+1}, X_{N}, . . . , X_{j′}, . . . , X₁ might be positions defined with respect to X₀ taken as reference position, representing for instance each a distance measured from X₀ along the section of route, i.e. the distance separating the considered remarkable position X_{j′} from X₀;
iteratively calculating, for i=0, . . . , N, a speed Vᵢ₊₁ at a position Xᵢ₊₁ according to:

$${V}_{i + 1}^{2} = {V}^{2} ( {X}_{i} , {X}_{i + 1} , {V}_{i} ) = {V}_{i}^{2} + [ 2 \cdot {g}^{EBH , Xi} ( {V}_{i} ) + M ( {X}_{i} ) \cdot g \cdot gradient ( {X}_{i} ) ] \cdot ( {X}_{i + 1} - {X}_{i} ) \qquad ( Eq . 1 )$$

wherein
Xᵢ₊₁ is, when starting from the final position X₀ and following the section of route towards (in direction of) the position X, the remarkable position of the subset S′ that is encountered on the section of route after the position X (i.e. that is directly next to the position Xᵢ along the route when starting from the final position X₀ and moving along the route towards the position X);
g^{EBR,Xi}(Vᵢ) is the emergency brake rate value (i.e. deceleration rate) at the position Xᵢ for the speed Vᵢ: g^{EBR,Xi}(Vᵢ)=g^{X}^{ᵢ}^{,v}^{ᵢ}. In particular, if X₀ is not one of the remarkable positions, then if X₀ is located, along the route, between the remarkable position X₁ and a remarkable position Xₐ of the set S (X₁ and Xₐ being direct neighbors to the position X₀), then g^{EBR,X0}(V₀)=g^{EBR,Xa}(V=V₀)=g^{X}^{ₐ}^{,v0};
g is the gravity, i.e., g=9.81 m/s² (at sea level)
gradient (Xᵢ)=[h(Xᵢ)−h(Xᵢ₊₁)]/(Xᵢ−Xᵢ₊₁), wherein h(Xᵢ) is the height at the position Xᵢ;
M(Xᵢ)=Mₑ/(Mₑ+Mᵢₙ) if gradient (Xᵢ)>0, otherwise, if gradient (Xᵢ)≤0, then M(Xᵢ)=M_{f}/(M_{f}+Mᵢₙ), wherein Mₑ is the mass of the guided vehicle when it is empty, M_{f} is the mass of the guided vehicle comprising a load (e.g. passengers), and Mᵢₙ is the inertial mass of the guided vehicle;
and wherein the processing unit is configured for automatically setting the speed limit value of Vₗᵢₘᵢₜ as Vₗᵢₘᵢₜ=V_{N+1}.

In other words, the EB system according to the invention is able to calculate, notably thanks to the EBR function, a speed limit that will take into account variations of the adhesion along the route it has to follow for reaching the final position. The iterative calculation typically gives rise to a curve as schematically represented by the continuous line 51 in FIG. 5, which shows the calculated speed V²ᵢ₊₁ for different remarkable positions Xᵢ₊₁.

Preferentially, the processing unit according to the invention is further configured for, and the method comprises, at each iteration, automatically testing whether the emergency brake rate value changes between Xᵢ₊₁ and Xᵢ when considering the calculated speed Vᵢ₊₁. For instance, if g^{EBR,X}^{ᵢ}(V) is a piecewise constant function as described earlier in connection with FIG. 2, wherein the piecewise constant function takes constant values on successive speed intervals according to

$${g}^{EBR , Xi} ( V ) = {γ}^{{X}_{i} , {V}_{t}^{EB , {X}_{i}}} = constant\_t$$

if Vₜ₋₁^{EB,P}^{ⱼ}≤V<Vₜ^{EB,P}^{ⱼ}), then such a piecewise constant function comprises speed intervals like [V₁^{EB,x}^{ᵢ}, V₂^{EB,x}^{ᵢ}[, [V₂^{EB,x}^{ᵢ}, V₃^{EB,x}^{ᵢ}[, . . . , [Vₜ₋₁^{EB,x}^{ᵢ}, Vₜ^{EB,x}^{ᵢ}[, [Vₜ^{EB,x}^{ᵢ}, Vₜ₊₁^{EB,x}^{ᵢ}[, . . . , [V_{Q-1}^{EB,x}^{ᵢ}, V_{Q}^{EB,x}^{ᵢ}[, wherein Vₜ₋₁^{EB,x}^{ᵢ} and Vₜ^{EB,x}^{ᵢ} are emergency brake speed values representing the boundaries of the t^{th} speed interval, and wherein the constant values γ^{X}^{ᵢ}^{,V}^{ₜ}^{^{EB,x}}ⁱ obtained for t=1, . . . , Q are preferentially each different (see for instance the line segments 220 of the piecewise constant function illustrated in FIG. 2). Typically, if V₀ belongs to a speed interval associated to a first A of the line segments 220 and thus to a first value of the EBR function, and the next calculated speed according to the iteration, which is then V₁ (V₁ being greater than V₀), does not belong to the first line segment but for instance to a third C line segment 220 associated to a third value of the EBR function, this means that for each change of the EBR function value that takes place between the first value and the third value, one has to determine the position that corresponds to the speed at which the change takes place. In the current example, the position corresponding to the speed V^{EB,Pj}^{_{Q−1}} and the position corresponding to the speed V^{EB,Pj}^{_{Q−2}} have thus to be determined. This enables to take into account variations of the EBR function due to changes of guided vehicle speed.

The above-mentioned testing is typically implemented by the processing unit, e.g. its processor, by executing instructions that might be comprised in the memory of the EB system. In particular, in the case of the EBR function being a piecewise constant function, then the testing comprises:
defining a parameter k whose value is configured for being iteratively increased by 1 unit;
defining an intermediate position X_{i,k} and an intermediate speed V_{i,k}, and setting initially X_{i,k}=Xᵢ and V_{i,k}=Vᵢ;
setting an initial value of the parameter k to 0, i.e. k=0;
   the testing further comprising the following testing steps:
determining whether g^{EBR,Xi,k} (Vᵢ₊₁)=g^{EBR,Xi,k} (V_{i,k}); and
if yes, then continuing the iteration process wherein i is incremented by one unit (i.e. i=i+1), otherwise:
(i) determining the speed interval to which V_{i,k} belongs to, i.e. for which value S taken by t one has V_{S}^{EB,x}^{ᵢ}≤V_{i,k}<V_{S+1}^{EB,x}^{ᵢ} and setting an emergency brake speed value V^{EB,Xi,k}=V_{S+1}^{EB,x}^{ᵢ}
(ii) determining a next intermediate position X_{i,k+1} according to

$${X}_{i , k + 1} = {X}_{i , k} + ( {( {V}^{EB , Xi , k} )}^{2} - {{V}^{2}}_{i , k} ) / [ 2 \cdot {g}^{EBR , Xi , k} ( {V}_{i , k} ) + M ( {X}_{i , k} ) \cdot g \cdot gradient ( {X}_{i , k} ) ]$$

(iii) setting V²_{i,k+1}=(V^{EB,Xi,k})²;
(iv) setting V²ᵢ₊₁=V²(X_{i,k+1},Xᵢ₊₁, V_{i,k+1});
(v) incrementing k by one unit;
and repeating the testing steps.

According to a first preferred embodiment, the method comprises, and the processing unit is further configured for, automatically determining, for each remarkable position of the set S′ to which a speed constraint is assigned to, i.e. for each remarkable positions of type III of the set S′, whether the speed Vᵢ₊₁ calculated for the remarkable position of type III is greater than the speed constraint associated to the remarkable position of type III, and in the affirmative, then the processing unit is configured for setting X₀ equal to the remarkable position of type III and V₀ equal to the speed constraint, and for restarting anew the iterative calculation process over i, otherwise ignoring the speed constraint and continuing the iteration over i. This enables the EB system to check that the newly calculated speed Vᵢ₊₁ at a remarkable position to which a speed constraint is assigned to satisfies the speed constraint imposed at the remarkable position.

According to a second preferred embodiment, at each iteration and after the testing, the method comprises, and the processing unit is further configured for, automatically performing another testing configured for determining whether a speed constraint V_{constraint speed} applying to (i.e. that has to be satisfied by) the guided vehicle at a position X_{constraint speed} comprised between X_{R} and X_{F}=Xᵢ₊₁ would be more restrictive than Vᵢ₊₁, and, in the affirmative, setting X₀=X_{constraint speed} and V₀=V_{constraint speed}, and restarting anew the iterative calculation process over i, otherwise, ignoring the speed constraint, and continuing the iteration over i. Advantageously, this enables the EB system to take into account the guided vehicle length and a potential speed constraint or restriction applying at a position along the length of the guided vehicle when its front is located in X_{F}=Xᵢ₊₁.

Preferentially, for performing the other testing, the method comprises, and the processing unit is further configured for, as long as i≤N−1
iteratively calculating, for c=1, . . . , U_{X}_{ᵢ₊₁}, −1, a speed V_{X}_{_{i+1_}}_{int,c+1} at a position X_{X}_{_{i+1_}}_{int,c+1} according to:

$${V}_{{X}_{i + 1} \_ int , c + 1}^{2} = {V}^{2} ( {X}_{{X}_{i + 1} \_ int , c} , {X}_{{X}_{i + 1} \_ int , c + 1} , {V}_{{X}_{i + 1} \_ int , c} ) = {V}_{{X}_{i + 1} \_ int , c}^{2} + [ 2 \cdot {γ}^{EBR , {X}_{{X}_{i + 1} \_ int , c}} ( {V}_{{X}_{i + 1} \_ int , c} ) + M ( {X}_{{X}_{i + 1} \_ int , c} ) \cdot g \cdot gradient ( {X}_{{X}_{i + 1} \_ int , c} ) ] \cdot ( {X}_{{X}_{i + {1}_{int} , c + 1}} - {X}_{{X}_{i + 1} \_ int , c} )$$

$$wherein$$

$${V}_{{X}_{i + 1} \_ int , 1} = {V}_{i + 1} and {X}_{{X}_{i + 1} \_ int , 1} = {X}_{i + 1} ;$$

optionally, repeating the testing steps described previously with respect to the iteration over c, i.e, wherein at each iteration over c, the processing unit is configured for automatically testing whether the emergency brake rate value changes between X_{X}_{_{i+1_}}_{int,c+1} and X_{X}_{_{i+1_}}_{int,c} when considering the calculated speed V_{X}_{_{i+1_}}_{int,c+1},
determining for which value C′ of c′=0, . . . , U_{X}_{ᵢ₊₁}−1, the expression (V²_{Xi+1_int,c′+1}−V²_{c′})+V²₀ reaches a minimum value, and
if the minimum value is smaller than V²_{constraint speed}, then ignoring the speed constraint and continuing the iteration over i, otherwise setting X₀=Xᵢ₊₁ and V₀=V_{constraint speed} and restarting anew the iterative calculation process over i.

As defined earlier, “U_{X}_{ᵢ₊₁}” is equal to the number of positions (or elements) comprised within the set L3_{Xi+1} of internal positions defined for the guided vehicle being at the position Xᵢ₊₁. In other words, for performing the another testing, the processing unit preferentially determines iteratively, for each internal position comprised in the set L3_{Xi+1} that are located between the front end and rear end of the guided vehicle when considering its front end located in position Xᵢ₊₁, the speed associated to the concerned internal position by solving Eq. 1 for the concerned internal position, and then it determines if the minimum speed value obtained among the different speeds calculated for the internal positions is smaller than the speed constraint. In the affirmative, the iteration over i can continue, otherwise, the iteration over i has to restart by taking into account the more restrictive speed constraint.

In particular, at the end of the iteration, i.e. for i=N, the method comprises, and the processing unit is further configured for, setting X_{F}=X, and for automatically determining if, between the position X_{F}=X and the position X_{R}, there is any internal position X_{intern_Vlim} requiring a lower value of the speed limit Vₗᵢₘᵢₜ than the speed limit value obtained as Vₗᵢₘᵢₜ=V_{N+1} (when X_{F}=X), and, in the affirmative, for setting the value of Vₗᵢₘᵢₜ equal to the lower value. This is better illustrated by FIG. 5, wherein the set of internal positions is L3_{X8}={X₈=X_{X8_int,1}, X_{X8_int,2}, X_{X8_int,3}, X_{X8_int,4}} wherein U_{X8}=4. For each of the internal positions, the speed is calculated (see “Speed²”, i.e. the speed raised to the power of two, used for the ordinate of the graphic shown in FIG. 5), and it is determined whether the speed calculated for an internal position is more restrictive than the other speeds calculated for the internal positions. The more restrictive speed is then taken as the speed limit Vₗᵢₘᵢₜ 531. In FIG. 5, the different curves 51-54 are each obtained by solving Eq. 1 for X=X₈ while imposing the speed V₀ at one of the internal positions of the guided vehicle when the latter is located in X₀. This enables to determine, when the guided vehicle is located in X=X₈, whether one of the speeds associated to an internal position and that is obtained via Eq. 1, i.e. corresponding to references 511, 521, 531, 541 in FIG. 5, is more restrictive than the other and to fix the speed limit Vₗᵢₘᵢₜ as equal to the more restrictive speed, which would correspond to reference 521 in the case illustrated by FIG. 5.

Preferentially, for determining X_{intern_Vlim}, the processing unit is configured for:
iteratively calculating, for c=1, . . . , U_{X}_{_{N+1}}−1, a speed

$${V}_{{X}_{N + 1} \_ int , c + 1}$$

at a position

$${X}_{{X}_{N + 1} \_ int , c + 1}$$

according to:

$${V}_{{X}_{N + 1} \_ int , c + 1}^{2} = {V}^{2} ( {X}_{{X}_{N + 1} \_ int , c} , {X}_{{X}_{N + 1} \_ int , c + 1} , {V}_{{X}_{N + 1} \_ int , c} ) = {V}_{{X}_{N + 1} \_ int , c}^{2} + [ 2 \cdot {γ}^{EBR , {X}_{{X}_{N + 1} \_ int , c}} ( {V}_{{X}_{N + 1} \_ int , c} ) + M ( {X}_{{X}_{N + 1} \_ int , c} ) \cdot g \cdot gradient ( {X}_{{X}_{N + 1} \_ int , c} ) ] \cdot ( {X}_{{X}_{N + {1}_{int} , c + 1}} - {X}_{{X}_{N + 1} \_ int , c} )$$

$$wherein$$

$${V}_{{X}_{N + 1} \_ int , 1} == {V}_{N + 1} and {X}_{{X}_{N + 1} \_ int , 1} = {X}_{N + 1} ;$$

optionally, repeating the testing steps previously described with respect to the iteration over c, i.e, wherein at each iteration over c, the processing unit is configured for automatically testing whether the emergency brake rate value changes between

$${X}_{{X}_{N + 1} \_ int , c + 1} and {X}_{{X}_{N + 1} \_ int , c}$$

when considering the calculated speed

$${V}_{{X}_{N + 1} \_ int , c + 1} ;$$

determining for which value C″ of c″=0, . . . , U_{Xi+1}−1, the expression (V²_{X}_{_{N+1_int,c″+1}}−V²_{c″})+V²₀ reaches a minimum value, and
if the minimum value is smaller than V₂N+1, then setting the value of Vₗᵢₘᵢₜ equal to sqrt (V²_{X}_{_{N+1_}}_{int,c″+1}) wherein X_{intern_Vlim}=X_{N+1_int,c″+1}, otherwise, keeping Vₗᵢₘᵢₜ equal to V_{N+1}.

Preferentially, the method comprises, and the processing unit of the EB system is further configured for, taking into account an altitude error when calculating the speed limit Vₗᵢₘᵢₜ. For instance, it might be configured for automatically lowering the value of Vₗᵢₘᵢₜ by an amount calculated in function of an altitude error hₑ in order to obtain a final value for Vₗᵢₘᵢₜ that is equal to sqrt (V²ₗᵢₘᵢₜ−2·g·M_{f}/(M_{f}+Mᵢₙ)·hₑ).

To summarize, the present invention proposes a new system and method capable to better adjust the speed limit used to trigger an emergency braking of a guided vehicle to the real distance required for braking the guided vehicle so that a safe distance (e.g. between the guided vehicle and another guided vehicle, or between the guided vehicle and a relevant position like a station) can be kept during the moving of the guided vehicle in case of an activation of the emergency braking. This is made possible by the new system and method according to the invention that use a variable emergency brake rate (the EBR function) as a function of speed of the guided vehicle in addition to, optionally, variations due to track or route gradient, and/or track or route conditions, and/or guided vehicle types (e.g. each type being characterized by a different length).

1. A system for initiating an emergency braking of a guided vehicle, wherein the system is configured for cooperating with a braking system of the guided vehicle, the system for initiating the emergency braking comprising:
a processing unit configured for initiating the emergency braking if the processing unit detects that a guided vehicle speed V at a guided vehicle position X exceeds a speed limit Vₗᵢₘᵢₜ defined for the position X in order to ensure a speed V₀ at a final position X₀ located forward of the guided vehicle on a route followed by the guided vehicle;
said processing unit being configured for automatically determining the speed limit Vₗᵢₘᵢₜ for the position X from an emergency brake rate function which varies as a function of the guided vehicle speed V at a remarkable position Pⱼ.

2. The system according to claim 1, comprising a memory configured to store:
a set S of said remarkable positions Pⱼ with j=1, . . . , M, i.e. S={P₁, . . . , P_{M}} with M≥1, along the route to be followed by the guided vehicle; and
for each remarkable position Pⱼ, an emergency brake rate g^{EBR,P}^{ⱼ}(V) that is a function of the speed V of the guided vehicle at the remarkable position Pⱼ, with G^{EBR,P}^{ⱼ}(V)=g^{P}^{ⱼ}^{,v}.

3. The system according to claim 2, wherein said processing unit is configured for automatically determining, for a position T along the route, a set L3_{T} of guided vehicle internal positions that are located within the guided vehicle between a front end and a rear end thereof, wherein X_{F} is a position of the front end of the guided vehicle and X_{R} is a position of the rear end, with |X_{F}−X_{R}|=a guided vehicle length L, and wherein the processing unit is configured for:
determining a first set L1_{X0} of internal positions X^{intern_1,X}^{₀} located along the length of the guided vehicle, between the front end position X_{F} of the guided vehicle and the rear end position X_{R}, which, when the front end of the guided vehicle is located at the final position X₀, i.e. X_{F}=X₀, correspond each to one of the remarkable positions Pⱼ;
determining a second set L2_{T} of guided vehicle internal positions X^{intern_2,T} located, along the length of the guided vehicle, between X_{F} and X_{R}, which, when the front end of the guided vehicle is located at the position T, including T=X_{F}=X, correspond each to one of the remarkable positions Pⱼ;
creating the set L3_{T} as a union of L1_{X0} and L2_{T}, wherein L3_{T} further comprises the positions X_{F}=T and X_{R}, wherein, for simplicity, L3_{T} is written as L3_{T}={X_{T_int,f}} with f=1, . . . , U_{T}, U_{T} being equal to a number of positions comprised within L3_{T} for the position T, and wherein, for simplicity, the positions X_{T_int,f} are ordered from the most distant position from X_{F} to the closest position to X_{F} with decreasing f, that is X_{T_int,U}_{_{T}}=X_{R}, X_{T_int,U}_{_{T−1}}, . . . , X_{T_int,2}, X_{T_int,1}=X_{F};
wherein said processing unit is further configured for automatically adding, to the set S of remarkable positions, for each internal position X_{T_int,f} comprised in L3_{T}, a first position that corresponds to the internal position X_{T_int,f} when the front end of the guided vehicle is located in X₀ and a second position that corresponds to the internal position X_{T_int,f} when the front end is located in T, when such a first position or second position, respectively, is not yet comprised within S.

4. The system according to claim 2, wherein said processing unit is configured for automatically calculating the speed limit Vₗᵢₘᵢₜ by implementing an iterative calculation process, wherein the iterative calculation process comprises:
an automatic determination of a subset S′ of the set S of remarkable positions Pⱼ comprised along a section of the route defined for the guided vehicle, wherein said section of the route is comprised between the current position X of the guided vehicle and the final position X₀, wherein the speed of the guided vehicle at said final position is the final speed V₀ that is a predefined parameter, wherein the subset S′ comprises N of said remarkable positions Pⱼ, which, for simplicity, are ordered in the subset S′ according to an increasing distance from the final position X₀ and noted X₁, . . . , X_{N} with N≤M, namely, S′={Xⱼ′} with j′=1, . . . , N;
an iterative calculation, for I=0, . . . , N, of a speed Vᵢ₊₁ at a position Xᵢ₊₁ according to:
$${{V}^{2}}_{i + 1} = {V}^{2} ( {X}_{i} , {X}_{i + 1} , {V}_{i} ) = {{V}^{2}}_{i} + [ 2 \cdot {g}^{EBR , Xi} ( {V}_{i} ) + M ( {X}_{i} ) \cdot g \cdot gradient ( {X}_{i} ) ] \cdot ( {X}_{i + 1} - {X}_{i} )$$
wherein
Xᵢ₊₁ is, when starting from the final position X₀ and following said section of the route towards the position X, the remarkable position of said subset S′ that is encountered on said section of the route after the position Xᵢ;
g^{EBR,Xi}(Vᵢ) is the emergency brake rate value at the position Xᵢ for the speed Vᵢ: g^{EBR,Xi}(Vᵢ)=g^{Xi,vi};
g is the force of gravity, namely, g=9.81 m/s² at sea level;
gradient(Xᵢ)=[h(Xᵢ)−h(Xᵢ₊₁)]/(Xᵢ−Xᵢ₊₁), wherein h(Xᵢ) is a height at the position Xᵢ;
M(Xᵢ)=Mₑ/(Mₑ+Mᵢₙ) if gradient(Xᵢ)>0, otherwise, if gradient (Xᵢ)≤0, then M(Xᵢ)=M_{f}/(M_{f}+Mᵢₙ), wherein Mₑ is a mass of the guided vehicle when empty, M_{f} is the mass of the guided vehicle with a load, and Mᵢₙ is an inertial mass of the guided vehicle;
with the processing unit being configured for automatically setting the speed limit value of Vₗᵢₘᵢₜ as Vₗᵢₘᵢₜ=V_{N+1}.

5. The system according to claim 4, wherein, at each iteration in the iterative calculation, the processing unit is configured for automatically testing whether the emergency brake rate value changes between Xᵢ₊₁ and Xᵢ when considering the calculated speed Vᵢ₊₁.

6. The system according to claim 5, wherein g^{EBR,Xi}(V) is a piecewise constant function taking constant values on successive speed intervals according to g^{EBR,Xi}(V)=γ^{X}^{ᵢ}^{,V}ₜ^{EB,X}^{ᵢ}=constant_t if Vₜ₋₁^{EB,x}^{ᵢ}≤V<Vₜ^{EB,x}^{ᵢ}, with t=1, . . . , Q, Q≥2 being a number of speed intervals, Q and t being positive integers; and
wherein the testing comprises:
defining a parameter k whose value is configured for being iteratively increased by 1 unit;
defining an intermediate position X_{i,k} and an intermediate speed V_{i,k}, and initially setting X_{i,k}=Xᵢ and V_{i,k}=Vᵢ;
setting an initial value of the parameter k to 0, namely, k=0; and
wherein the testing further comprises:
determining whether g^{EBR,Xi,k}(Vᵢ₊₁)=g^{EBR,Xi,k}(V_{i,k}); and
if g^{EBR,Xi,k}(Vᵢ₊₁)=g^{EBR,Xi,k}(V_{i,k}), continuing the iteration process wherein i is incremented by one unit (i=i+1), otherwise
(i) determining the speed interval to which V_{i,k} belongs, namely, for which value S taken by t one has V^{EB,Xi}_{S}≤V_{i,k}<V^{EB,Xi}_{S+1} and setting an emergency brake speed value V^{EB,Xi,k}=V^{EB,Xi}_{S+1}
(ii) determining a next intermediate position X_{i,k+1} according to
$${X}_{i , k + 1} = {X}_{i , k} + ( {( {V}^{EB , Xi , k} )}^{2} - {{V}^{2}}_{i , k} ) / [ 2 \cdot {g}^{EBR , Xi , k} ( {V}_{i , k} ) + M ( {X}_{i , k} ) \cdot g \cdot gradient ( {X}_{i , k} ) ] ;$$
$$setting {{V}^{2}}_{i , k + 1} = {( {V}^{EB , Xi , k} )}^{2} ; \qquad ( iii )$$
$$setting {{V}^{2}}_{i + 1} = {V}^{2} ( {X}_{i , k + 1} , {X}_{i + 1} , {V}_{i , k + 1} ) ; \qquad ( iv )$$
(v) incrementing k by one unit; and
repeating the testing steps.

7. The system according to claim 4, wherein for each remarkable position that belongs to the set S′ and to which a speed constraint is associated, said processing unit is configured for automatically determining whether the speed Vᵢ₊₁ calculated for said remarkable position is greater than the speed constraint associated to said remarkable position, and, in the affirmative, the processing unit is configured for setting X₀ equal to said remarkable position and V₀ equal to said speed constraint, and for restarting anew said iterative calculation process over i, and otherwise, ignoring said speed constraint and continuing the iteration over i.

8. The system according to claim 5, wherein, at each iteration and after said testing, said processing unit is further configured for automatically performing another testing configured for determining whether a speed constraint V_{constraint speed} applying to the guided vehicle at a position X_{constraint speed} comprised between X_{R} and X_{F}=Xᵢ₊₁ would be more restrictive than Vᵢ₊₁, and, in the affirmative, setting X₀=X_{constraint speed} and V₀=V_{constraint speed} and restarting anew the iterative calculation process over i, and otherwise, ignoring said speed constraint, and continuing the iteration over i.

9. The system according to claim 8, wherein for performing the other testing, said processing unit is configured for, as long as I≤N−1:
iteratively calculating, for c=1, . . . , U_{X}_{ᵢ₊₁}−1, a speed V_{X}_{_{i+1_}}_{int,c+1} at a position X_{X}_{_{i+1_}}_{int,c+1} according to:
$${{V}^{2}}_{Xi + 1 \_ int , c + 1} = {V}^{2} ( {X}_{Xi + 1 \_ int , c} , {X}_{Xi + 1 \_ int , c + 1} , {V}_{Xi + 1 \_ int , c} ) = {{V}^{2}}_{Xi + 1 \_ int , c} + [ 2 \cdot {g}^{EBR , {X}_{Xi + 1 \_ int , c}} ( {V}_{Xi + 1 \_ int , c} ) + M ( {X}_{Xi + 1 \_ int , c} ) \cdot g \cdot gradient ( {X}_{Xi + 1 \_ int , c} ) ] \cdot ( {X}_{Xi + 1 \_ int , c + 1} - {X}_{Xi + 1 \_ int , c} )$$
$$wherein$$
$${V}_{Xi + 1 \_ int , 1} = {V}_{i + 1} and {X}_{Xi + 1 \_ int , 1} = {X}_{i + 1} ;$$
optionally, repeatedly testing whether the emergency brake rate value changes between Xᵢ₊₁ and Xᵢ when considering the calculated speed Vᵢ₊₁ with respect to the iteration over c, namely, wherein at each iteration over c, the processing unit is configured for automatically testing whether the emergency brake rate value changes between X_{X}_{_{i+1_}}_{int,c+1} and X_{X}_{_{i+1_}}_{int,c} when considering the calculated speed V_{X}_{_{i+1_}}_{int,c+1};
determining for which value C′ of c′=0, . . . , U_{X}_{ᵢ₊₁}−1, the expression (V²_{X}_{_{i+1_}}_{int, c′+1}−V²_{c′})+V²₀ reaches a minimum value; and
if the minimum value is smaller than V²_{constraint speed}, then ignoring said speed constraint and continuing the iteration over i, and otherwise setting X₀=Xᵢ₊₁ and V₀=V_{constraint speed} and restarting anew the iterative calculation process over i.

10. The system according to claim 3, wherein for performing the other testing, said processing unit is configured for, as long as I≤N−1:
iteratively calculating, for c=1, . . . , U_{X}_{ᵢ₊₁}−1, a speed V_{X}_{_{i+1_}}_{int,c+1} at a position X_{X}_{_{i+1_}}_{int,c+1} according to:
$${{V}^{2}}_{Xi + 1 \_ int , c + 1} = {V}^{2} ( {X}_{Xi + 1 \_ int , c} , {X}_{Xi + 1 \_ int , c + 1} , {V}_{Xi + 1 \_ int , c} ) = {{V}^{2}}_{Xi + 1 \_ int , c} + [ 2 \cdot {g}^{EBR , {X}_{Xi + 1 \_ int , c}} ( {V}_{Xi + 1 \_ int , c} ) + M ( {X}_{Xi + 1 \_ int , c} ) \cdot g \cdot gradient ( {X}_{Xi + 1 \_ int , c} ) ] \cdot ( {X}_{Xi + 1 \_ int , c + 1} - {X}_{Xi + 1 \_ int , c} )$$
$$wherein$$
$${V}_{Xi + 1 \_ int , 1} = {V}_{i + 1} and {X}_{Xi + 1 \_ int , 1} = {X}_{i + 1} ;$$
optionally repeatedly testing whether the emergency brake rate value changes between Xᵢ₊₁ and Xᵢ when considering the calculated speed Vᵢ₊₁ with respect to the iteration over c, namely, wherein at each iteration over c, the processing unit is configured for automatically testing whether the emergency brake rate value changes between X_{X}_{_{i+1_}}_{int,c+1} and X_{X}_{_{i+1_}}_{int,c} when considering the calculated speed V_{X}_{_{i+1_}}_{int,c+1};
determining for which value C′ of c′=0, . . . , U_{X}_{ᵢ₊₁}−1, the expression (V²_{X}_{_{i+1_}}_{int,c′+1}−V²_{c′})+V²₀ reaches a minimum value; and
if the minimum value is smaller than V²_{constraint speed}, then ignoring said speed constraint and continuing the iteration over i, and otherwise setting X₀=Xᵢ₊₁ and V₀=V_{constraint speed} and restarting anew the iterative calculation process over i.

11. The system according to claim 4, wherein, at an end of the iteration, namely, for i=N, the processing unit is further configured for setting X_{F}=X, and for automatically determining if, between the position X_{F}=X and said position X_{R}, there is any internal position X_{intern_Vlim} requiring a lower value of said speed limit Vₗᵢₘᵢₜ than the speed limit value obtained as Vₗᵢₘᵢₜ=V_{N+1}, and, in the affirmative, for setting the value of Vₗᵢₘᵢₜ equal to the lower value.

12. The system according to claim 11, wherein, for determining X_{intern_Vlim}, said processing unit is configured for
iteratively calculating, for c=1, . . . , U_{X}_{_{N+1}}−1, a speed V_{X}_{_{N+1_}}_{int,c+1} at a position X_{X}_{_{N+1_}}_{int,c+1} according to:
$${{V}^{2}}_{XN + 1 \_ int , c + 1} = {V}^{2} ( {X}_{XN + 1 \_ int , c} , {X}_{XN + 1 \_ int , c + 1} , {V}_{XN + 1 \_ int , c} ) = {{V}^{2}}_{XN + 1 \_ int , c} + [ 2 \cdot {g}^{EBR , {X}_{XN + 1 \_ int , c}} ( {V}_{XN + 1 \_ int , c} ) + M ( {X}_{XN + 1 \_ int , c} ) \cdot g \cdot gradient ( {X}_{XN + 1 \_ int , c} ) ] \cdot ( {X}_{XN + 1 \_ int , c + 1} - {X}_{XN + 1 \_ int , c} )$$
$$wherein$$
$${V}_{XN + 1 \_ int , 1} = {V}_{N + 1} and {X}_{XN + 1 \_ int , 1} = {X}_{N + 1} ;$$
optionally repeatedly testing whether the emergency brake rate value changes between Xᵢ₊₁ and Xᵢ when considering the calculated speed Vᵢ₊₁ with respect to the iteration over c, namely, wherein at each iteration over c, said processing unit is configured for automatically testing whether the emergency brake rate value changes between X_{X}_{_{N+1_}}_{int,c+1} and X_{X}_{_{N+1_}}_{int,c} when considering the calculated speed V_{X}_{_{N+1_}}_{int,c+1};
determining for which value C″ of c″=0, . . . , U_{X}_{ᵢ₊₁}−1, the expression (V²_{X}_{_{N+1_}}_{int,c″+1}−V²_{c″})+V²₀ reaches a minimum value, and
if said minimum value is smaller than V²_{N+1}, setting the value of Vₗᵢₘᵢₜ equal to sqrt (V²_{X}_{_{N+1_}}_{int,c″+1}), otherwise keeping Vₗᵢₘᵢₜ equal to V_{N+1}.

13. The system according to claim 3, wherein, for determining X_{intern_Vlim}, said processing unit is configured for
iteratively calculating, for c=1, . . . , U_{X}_{_{N+1}}−1, a speed V_{X}_{_{N+1_}}_{int,c+1} at a position X_{X}_{_{N+1_}}_{int,c+1} according to:
$${{V}^{2}}_{XN + 1 \_ int , c + 1} = {V}^{2} ( {X}_{XN + 1 \_ int , c} , {X}_{XN + 1 \_ int , c + 1} , {V}_{XN + 1 \_ int , c} ) = {{V}^{2}}_{XN + 1 \_ int , c} + [ 2 \cdot {g}^{EBR , {X}_{XN + 1 \_ int , c}} ( {V}_{XN + 1 \_ int , c} ) + M ( {X}_{XN + 1 \_ int , c} ) \cdot g \cdot gradient ( {X}_{XN + 1 \_ int , c} ) ] \cdot ( {X}_{XN + 1 \_ int , c + 1} - {X}_{XN + 1 \_ int , c} )$$
$$wherein$$
$${V}_{XN + 1 \_ int , 1} = {V}_{N + 1} and {X}_{XN + 1 \_ int , 1} = {X}_{N + 1} ;$$
optionally repeatedly testing whether the emergency brake rate value changes between Xᵢ₊₁ and Xᵢ when considering the calculated speed Vᵢ₊₁ with respect to the iteration over c, namely, wherein at each iteration over c, said processing unit is configured for automatically testing whether the emergency brake rate value changes between X_{X}_{_{N+1_}}_{int,c+1} and X_{X}_{_{N+1_}}_{int,c} when considering the calculated speed V_{X}_{_{N+1_}}_{int,c+1};
determining for which value C″ of c″=0, . . . , U_{X}_{ᵢ₊₁}−1, the expression (V²_{X}_{_{N+1_}}_{int,c″+1}−V²_{c″})+V²₀ reaches a minimum value, and
if said minimum value is smaller than V²_{N+1}, setting the value of Vₗᵢₘᵢₜ equal to sqrt (V²_{X}_{_{N+1_}}_{int,c″+1}), otherwise keeping Vₗᵢₘᵢₜ equal to V_{N+1}.

14. The system according to claim 13, wherein said processing unit is configured for automatically taking into account an altitude error when calculating said speed limit Vₗᵢₘᵢₜ.

15. A method for initiating an emergency braking of a guided vehicle by way of a system that is configured for cooperating with a braking system of the guided vehicle, the method comprising:
determining whether a guided vehicle speed V at a guided vehicle position X exceeds a speed limit Vₗᵢₘᵢₜ defined for the position X for the guided vehicle;
initiating the emergency braking when the guided vehicle speed V at the guided vehicle position X exceeds the speed limit Vₗᵢₘᵢₜ in order to ensure, for the guided vehicle, a speed V₀ at a final position X₀ located upfront the guided vehicle on a route followed by the guided vehicle; and thereby:
automatically determining the speed limit Vₗᵢₘᵢₜ for the position X from an emergency brake rate function which, for a given remarkable position Pⱼ, varies as a function of the guided vehicle speed at the remarkable position Pⱼ.

16. The method according to claim 15, which further comprises storing in a memory of the system:
a set S of said remarkable positions Pⱼ with j=1, . . . , M, namely, S={P₁, . . . , P_{M}} with M≥1, along the route to be followed by the guided vehicle; and
for each remarkable position Pⱼ, an emergency brake rate g^{EBR,P}^{ⱼ} that is a function of the speed V of the guided vehicle at the remarkable position Pⱼ, namely, g^{EBR,P}^{ⱼ}(V)=g^{P}^{ⱼ}^{,v}.

17. The method according to claim 16, which comprises automatically calculating the speed limit Vₗᵢₘᵢₜ by implementing an iterative calculation process, wherein the iterative calculation process comprises:
an automatic determination of a subset S′ of the set S of remarkable positions Pⱼ comprised along a section of the route defined for the guided vehicle, wherein the section of the route is comprised between the current position X of the guided vehicle and the final position X₀ to be reached by the guided vehicle when moving along said section of the route from the current position X towards the final position X₀ in a given direction of travel, wherein the speed of the guided vehicle at the final position is the final speed V₀ that is a predefined parameter, wherein the subset S′ comprises N of the remarkable positions Pⱼ, which, for simplicity, are ordered in the set S′ according to increasing distance from the final position X₀ and noted X₁, . . . , X_{N} with N≤M, namely, S′={Xⱼ′} with j′=1, . . . , N;
iteratively calculating, for I=0, . . . , N, a speed Vᵢ₊₁ at a position Xᵢ₊₁ according to:
$${{V}^{2}}_{i + 1} = {V}^{2} ( {X}_{i} , {X}_{i + 1} , {V}_{i} ) = {{V}^{2}}_{i} + [ 2 \cdot {g}^{EBR , Xi} ( {V}_{i} ) + M ( {X}_{i} ) \cdot g \cdot gradient ( {X}_{i} ) ] \cdot ( {X}_{i + 1} - {X}_{i} )$$
wherein
Xᵢ₊₁ is, when starting from the final position X₀ and following the section of the route towards the position X, the remarkable position of the subset S′ that is encountered on the section of the route after the position Xᵢ;
g^{EBR,Xi}(Vᵢ) is the emergency brake rate value at the position Xᵢ for the speed Vᵢ: g^{EBR,Xi}(Vᵢ)=g^{X}^{ᵢ}^{,v}^{ᵢ};
g is the force of gravity, namely, g=9.81 m/s² at sea level;
gradient(Xᵢ)=[h(Xᵢ)−h(Xᵢ₊₁)]/(Xᵢ−Xᵢ₊₁), wherein h(Xᵢ) is the height at the position Xᵢ;
M(Xᵢ)=Mₑ/(Mₑ+Mᵢₙ) if gradient(Xᵢ)>0, otherwise, if gradient (Xᵢ)≤0, then M(Xᵢ)=M_{f}/(M_{f}+Mᵢₙ), wherein Mₑ is a mass of the guided vehicle when empty, M_{f} is the mass of the guided vehicle with a load, and Mᵢₙ is an inertial mass of the guided vehicle; and
automatically setting the speed limit value Vₗᵢₘᵢₜ to Vₗᵢₘᵢₜ=V_{N+1}.
